(19) United States
(12) Patent Application Publication
(10) Pub. No.: US 2017/0182436 A1
(43) Pub. Date: Jun. 29, 2017

(54) SLURRY FILTERING DEVICE

(71) Applicant: Kenneth WONG, Zhubei City (TW)

(72) Inventor: Kenneth WONG, Zhubei City (TW)

(21) Appl. No.: 15/388,417

(22) Filed: Dec. 22, 2016

(30) Foreign Application Priority Data
Dec. 25, 2015 (TW) 104143743

(51) Int. Cl. B01D 29/58; B01D 29/11

(52) U.S. Cl. CPC B01D 29/58; B01D 29/114; B01D 29/117

(57) ABSTRACT

A slurry filtering device is provided, including a shell body, having a receiving space, an outlet portion and an inlet portion, the outlet portion and the inlet portion respectively communicating with the receiving space, the inlet portion and the outlet portion defining a flow passage therebetween; a first filter, received in the receiving space and connected to the inlet portion, the first filter laterally arranged in the flow passage; a second filter, received in the receiving space and connected to the outlet portion, the second filter laterally arranged in the flow passage.

### BACKGROUND OF THE INVENTION

Field of the Invention

The present invention relates to a filtering device, and more particularly to a slurry filtering device.

Description of the Prior Art

Generally, a liquid (for example, a cutting fluid or a slurry) is often required to conduct a processing process, and the slurry is required in a chemical mechanical polishing (CMP) of a manufacturing process of a semiconductor. Before the slurry is used in the processing process, a user needs to make sure that sizes of particles of the slurry meet a requirement of the manufacturing process. Therefore, the slurry needs to be filtered through a filtering device before being used in the processing process so as to make sure that the slurry has a preferable quality.

A filtering device as disclosed in TWM492187 at least includes an outer shell, an inner shell and at least one filter material, the filter material is arranged between the outer shell and the inner shell, the outer shell has at least one inlet opening, and the inner shell has at least one outlet opening.

However, the filter material mentioned above is tightly arranged, and when a liquid flows through the filter material, fine particles may break through a restriction of pores of the filter material and penetrate the filter material because a pressure suddenly rises, and the liquid cannot be effectively filtered. In addition, when stringing at least two sets of the filtering devices, the user needs to string two independent filtering devices through a channel; therefore, a lot of spaces are wasted, and material cost increases. To effectively elevate a filtering efficiency of the filtering device to provide a preferable filtering quality is the goal that the present invention wants to work toward.

The present invention has arisen to mitigate and/or obviate the afore-described disadvantages.

### SUMMARY OF THE INVENTION

The major object of the present invention is to provide a slurry filtering device which can conduct double filtration to lower the risk that particles cannot be filtered out because of pressure variation during a filtering process. In addition, the slurry filtering device has a smaller volume and saves material costs, and the slurry filtering device decreases a space and a cost when being used in a semiconductor equipment. Furthermore, the slurry filtering process is pre-wetted to continuously provide preferable filtering effect and preferable filtering quality.

To achieve that above and other objects, a slurry filtering device is provided, including a shell body, having a receiving space, an outlet portion and an inlet portion, the outlet portion and the inlet portion respectively communicating with the receiving space, the inlet portion and the outlet portion defining a flow passage therebetween; a first filter, received in the receiving space and connected to the inlet portion, the first filter laterally arranged in the flow passage; a second filter, received in the receiving space and connected to the outlet portion, the second filter laterally arranged in the flow passage.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing of a preferred embodiment of the present invention;

FIG. 2 is a cross-sectional view of the preferred embodiment of the present invention;

FIG. 3 is a drawing showing the preferred embodiment of the present invention in use;

FIG. 4 is another cross-sectional view of the preferred embodiment of the present invention;

FIG. 5 is still another cross-sectional view of the preferred embodiment of the present invention; and

FIG. 6 is a drawing showing experimental results of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

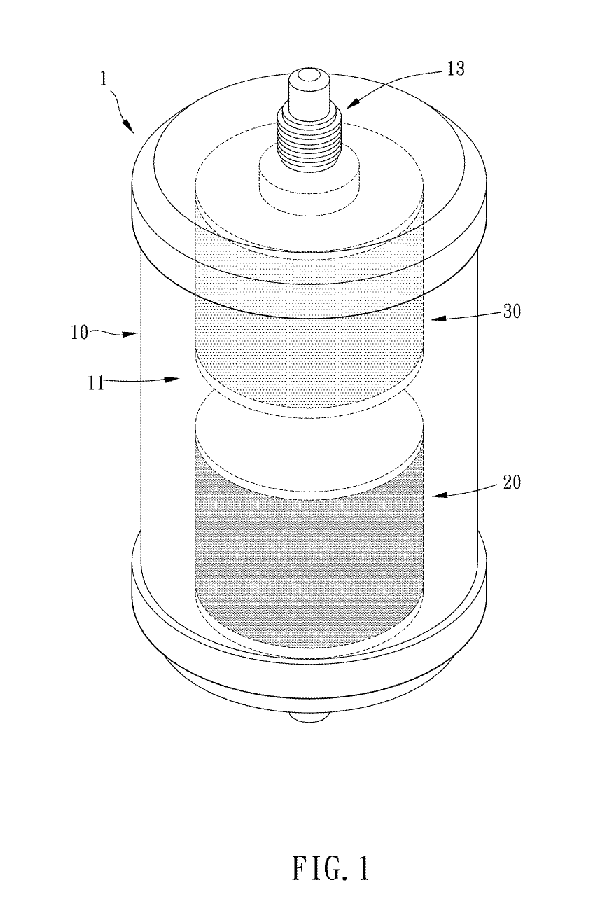

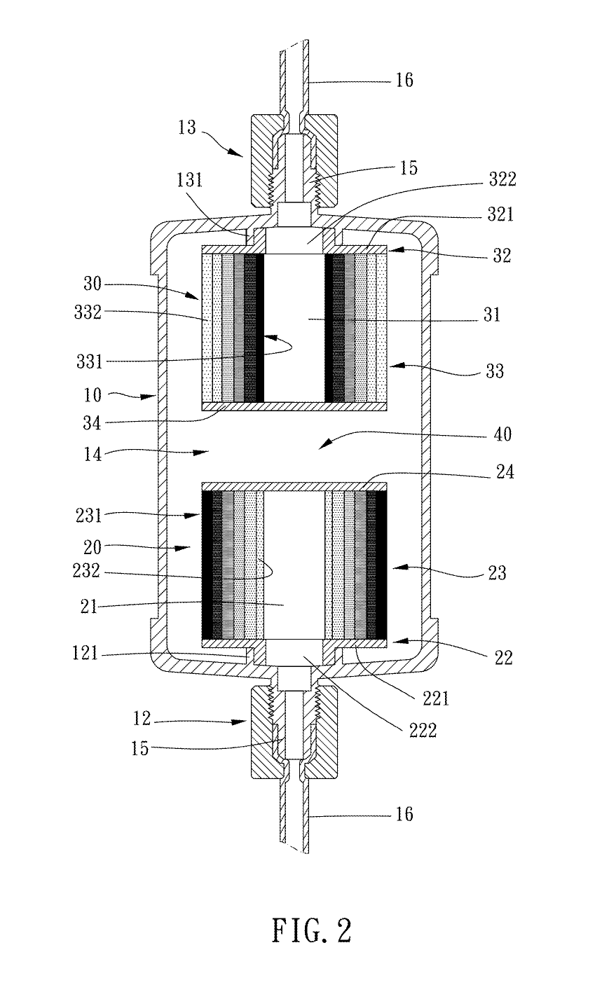

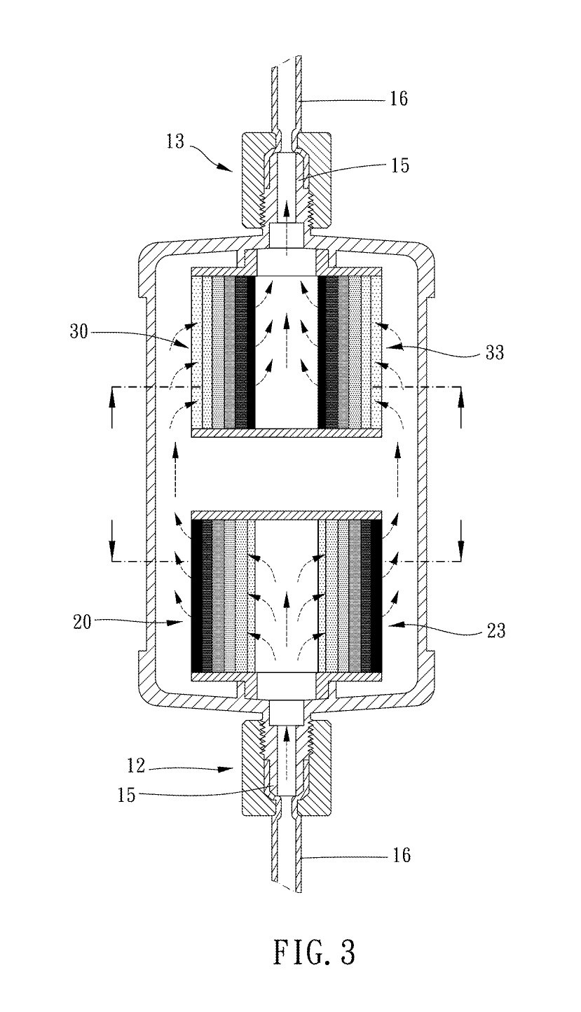

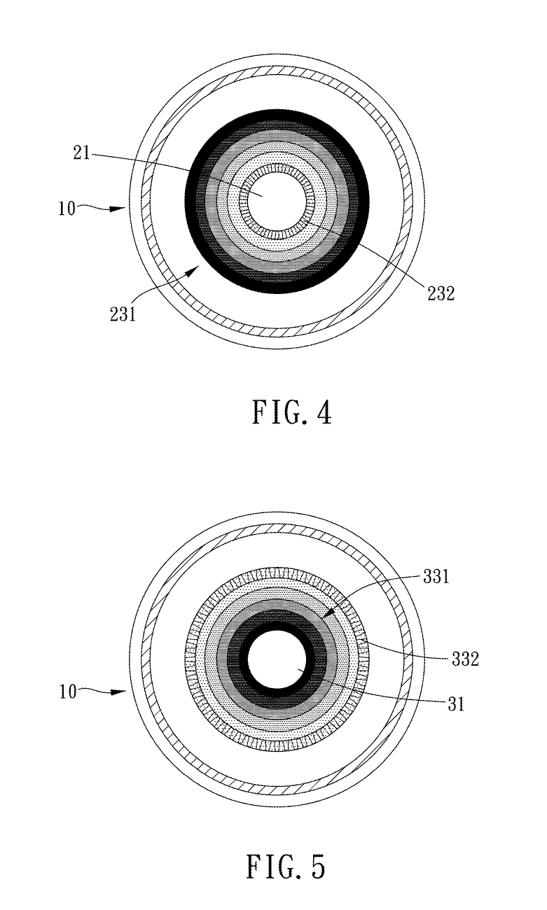

Please refer to FIGS. 1 to 5 for a preferred embodiment of the present invention. A slurry filtering device 1 includes a shell body 10, a first filter 20 and a second filter 30.

The shell body 10 has a receiving space 11, an inlet portion 12 and an outlet portion 13, the outlet portion 13 and the inlet portion 12 respectively communicate with the receiving space 11, the inlet portion 12 and the outlet portion 13 define a flow passage 14 therebetween, and the inlet portion 12 and the outlet portion 13 are respectively for, for example, a slurry to be imported and exported.

The first filter 20 is received in the receiving space 11 and connected to the inlet portion 12, and the first filter 20 is laterally arranged in the flow passage 14. Specifically, the first filter 20 defines a first passage 21 around a first axial direction, and the first passage 21 communicates with the inlet portion 12. For example, in this embodiment, the first filter 20 has a first cartridge member 22 and a first filtering medium 23, the first filtering medium 23 is arranged on the first cartridge member 22 and surroundingly forms the first passage 21, and the first cartridge member 22 is assembled to the inlet portion 12. More specifically, the first cartridge member 22 includes a first cover member 221, the first cover member 221 has a first opening hole 222 which communicates with the first passage 21, and the inlet portion 12 has a first engaging portion 121 which is protrudingly disposed on an inner wall of the shell body 10 so that the first cover member 221 is engaged with the first engaging portion 121, and the first opening hole 222 communicates with and between the first passage 21 and the inlet portion 12.

The second filter 30 is received in the receiving space 11 and connected to the outlet portion 13, and the second filter 30 is laterally arranged in the flow passage 14. Specifically, the second filter 30 defines a second passage 31 around a second axial direction, and the second passage 31 communicates with the outlet portion 13. For example, in this embodiment, the second filter 30 has a second cartridge member 32 and a second filtering medium 33, the second filtering medium 33 is arranged on the second cartridge member 32 and surroundingly forms the second passage 31, and the second cartridge member 32 is assembled to the outlet portion 13. More specifically, the second cartridge member 32 includes a second cover member 321, the second cover member 321 has a second opening hole 322 which communicates with the second passage 31, and the outlet portion 13 has a second engaging portion 131 which is protrudingly disposed on the inner wall of the shell body 10 so that the second cover member 321 is engaged with the second engaging portion 131, and the second opening hole 322 communicates with and between the second passage 31 and the outlet portion 13.

Specifically, the first filter 20 and the second filter 30 are separately arranged, and the first filter 20 and the second filter 30 are axially opposite to each other and have a separating space 40 therebetween. More specifically, in this embodiment, the first and second filters 20, 30 are respectively cylindrical, and the first and second filters 20, 30 are coaxially and spacingly arranged. The first filter 20 further includes a first side cover 24, and the first side cover 24 covers a side of the first filtering medium 23 neighboring to the second filter 30; similarly, the second filter 30 further includes a second side cover 34, the second side cover 34 covers a side of the second filtering medium 33 neighboring to the first filter 20, and the first side cover 24 and the second side cover 34 define the separating space 40 therebetween.

The first filtering medium 23 includes a plurality of first filtering layers 231, the first filtering layers 231 are layered around the first axial direction, and the first filtering layers 231 are gradually smaller in pore size from inside to outside. For example, the first filtering medium 23 has a first folded layer 232 on an inner side thereof, the first folded layer 232 is radially folded to and fro around the first axial direction and continuously layered circumferentially, the first folded layer 232 may be made of a thick PP non-woven fabric filter material, a folded structure of the first folded layer 232 increases a filtering area and a filtering efficiency, compared with other plurality of the first filtering layers 231, the first folded layer 232 is for filtering particles and foreign objects which have greater dimensions, and the first folded layer 232 has greater nominal pore sizes to provide a preferable flow efficiency. The first filtering layers 231 arranged on an outer side thereof are preferably smaller in pore size toward outside, at least a part of the first filtering layers 231 may include a PP filter material, and a nominal pore size of the PP filter material is smaller than 0.5 μm (for example, 0.2 μm). For example, the PP filter material may include thermal spraying PP nanometer diameter fiber and may have finer pores for filtering tinier particles.

The second filtering medium 33 includes a plurality of second filtering layers 331, the second filtering layers 331 are layered around the second axial direction, and the second filtering layers 331 are gradually smaller in pore size from outside to inside. For example, the second filtering medium 33 has a second folded layer 332 on an outer side thereof, the second folded layer 332 is radially folded to and fro around the second axial direction and continuously layered circumferentially, the second folded layer 332 may be made of the thick PP non-woven fabric filter material mentioned above, compared with other plurality of the second filtering layers 331, and the second folded layer 332 may have greater nominal pore sizes to provide a preferable flow efficiency be for filtering particles and foreign objects which have greater dimensions. The second filtering layers 331 arranged on an inner side thereof are preferably smaller in pore size toward inside, at least a part of the second filtering layers 331 may include the PP filter material mentioned above and may have finer pores for filtering tinier particles.

In actual practice, the inlet portion 12 and the outlet portion 13 are respectively include an expanded tube connector 15, and each said expanded tube connector 15 is for being liquid-tightly connected to a tube member 16. For example, the slurry filtering device 1 may be used in a point-of-use system (POU System) in a manufacturing process and used to string with a tube which transmits a slurry, the slurry is imported from the inlet portion to the slurry filtering device, and the slurry firstly passes through the first filter 20 and is filtered through the first filtering medium 23. Preferably, the first filtering medium 23 is gradually smaller in pore size from inside to outside, and the slurry passing through the first filtering medium 23 has a smaller pressure difference and is able to provide a preferable filtering efficacy. Specifically, the slurry passing through the first filter 20 flows toward the second filter 30, the slurry passes through the second filtering medium 33 (the second filtering medium 33 is gradually smaller in pore size from outside to inside) to be filtered, and the slurry is processed with double filtration; therefore, the tiny particles in the slurry can be effectively filtered out, the risk that the particles cannot be filtered because of pressure variation during a filtering process is lowered, and stability of the filtering effect and filtering quality can be maintained. It is to be noted that the slurry filtering device 1 which includes the first and second filters 20, 30 is integrally formed, so the slurry filtering device 1 is convenient to use, has a smaller volume and saves material costs, and the slurry filtering device 1 decreases a space and a cost when being used in a semiconductor equipment.

It is to be noted that a smallest pore of the second filtering medium 33 is smaller than a smallest pore of the first filtering medium 23. More specifically, the first filtering medium 23 conducts an initial filtering process, the slurry passes through the first filtering medium 23 to filter out the particles which have greater dimensions, and the slurry which goes through the initial filtering process passes through the second filtering medium 33 to filter out the tinier particles. Preferable, through the two filtering steps mentioned above, the filtering efficiency and quality can be effectively elevated, and service lives of the first and second filtering media 23, 33 can be prolonged.

The first and second filtering media 23, 33 are pre-wetted. More specifically, the slurry filtering device 1 may be pre-wetted via a pre-wetting liquid (for example, isopropyl alcohol) in the manufacturing process and flushed via deionized water, then the first and second filtering media 23, 33 are pre-wetted, and the slurry filtering device 1 which has been pre-wetted may be sterilized and packed in a package member. The slurry filtering device 1 which is pre-wetted has stable and smaller pressure drop and preferable retention efficiency so that the slurry filtering device 1 can stably and continuously provide preferable filtering effect and quality.

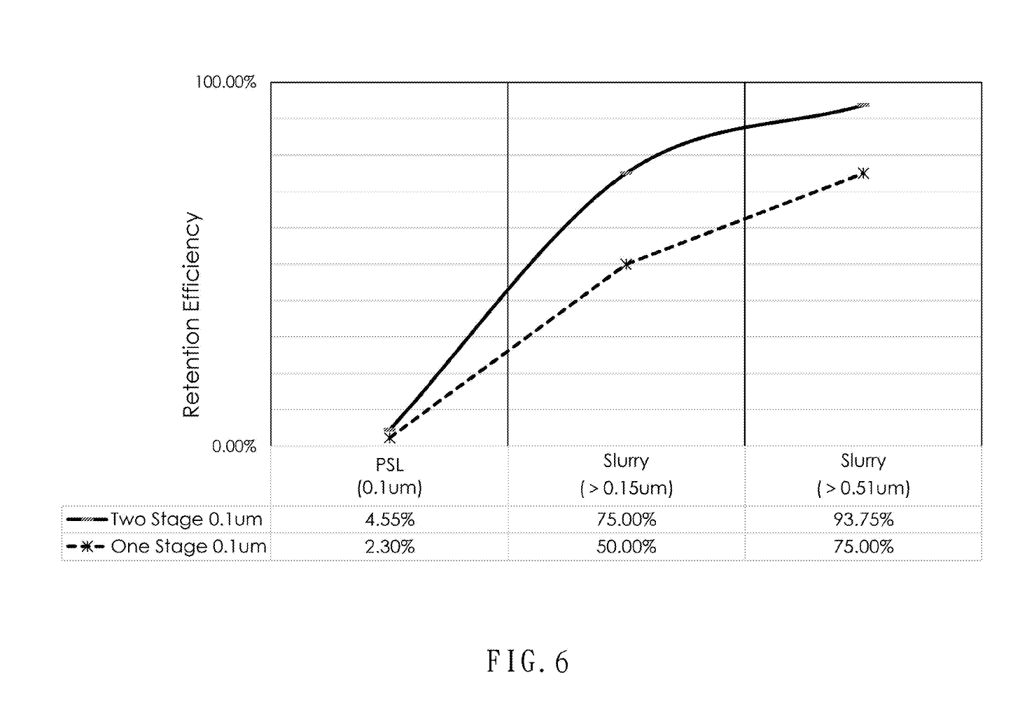

Please further refer to FIG. 6 for an examination result of the slurry filtering device 1 with double filtering stages (two stage) and a single filter with a single stage (one stage). The retention efficiency comparison of the slurry filtering device 1 and the single filter is shown in FIG. 6. Compared with the single filter, the slurry filtering device 1 with double filtering stages obviously has a more stable and preferable retention efficiency, and when in actual practice, the slurry filtering device 1 with double filtering stages allows the slurry to produce preferable filtering effect and quality stably and continuously.

Given the above, the slurry filtering device can conduct double filtration to lower the risk that particles cannot be filtered because of pressure variation during a filtering process. In addition, the slurry filtering device has a smaller volume and saves material costs, and the slurry filtering device decreases the space and the cost when being used in the semiconductor equipment. Furthermore, the slurry filtering process is pre-wetted to continuously provide preferable filtering effect and preferable filtering quality.

While we have shown and described various embodiments in accordance with the present invention, it should be clear to those skilled in the art that further embodiments may be made without departing from the scope of the present invention.

What is claimed is:

1. A slurry filtering device, including:
a shell body, having a receiving space, an outlet portion and an inlet portion, the outlet portion and the inlet portion respectively communicating with the receiving space, the inlet portion and the outlet portion defining a flow passage therebetween;
a first filter, received in the receiving space and connected to the inlet portion, the first filter laterally arranged in the flow passage;
a second filter, received in the receiving space and connected to the outlet portion, the second filter laterally arranged in the flow passage.

2. The slurry filtering device of claim 1, wherein the first filter defines a first passage around a first axial direction, the second filter defines a second passage around a second axial direction, the first passage communicates with the inlet portion, and the second passage communicates with the outlet portion.

3. The slurry filtering device of claim 2, wherein the first filter has a first cartridge member and a first filtering medium, the first filtering medium is arranged on the first cartridge member and surroundingly forms the first passage, the first cartridge member is assembled to the inlet portion, the second filter has a second cartridge member and a second filtering medium, the second filtering medium is arranged on the second cartridge member and surroundingly forms the second passage, and the second cartridge member is assembled to the outlet portion.

4. The slurry filtering device of claim 3, wherein the first filter and the second filter are separately arranged.

5. The slurry filtering device of claim 3, wherein the first cartridge member includes a first cover member, the first cover member communicates with the first passage, the second cartridge member includes a second cover member, the second cover member communicates with the second passage, the inlet portion has a first engaging portion which is protrudingly disposed on an inner wall of the shell body, the outlet portion has a second engaging portion which is protrudingly disposed on the inner wall of the shell body, and the first cover member and the second cover member are respectively engaged with the first engaging portion and the second engaging portion.

6. The slurry filtering device of claim 3, wherein the first filtering medium includes a plurality of first filtering layers, the first filtering layers are layered around the first axial direction, and the first filtering layers are gradually smaller in pore size from inside to outside.

7. The slurry filtering device of claim 3, wherein the second filtering medium includes a plurality of second filtering layers, the second filtering layers are layered around the second axial direction, and the second filtering layers are gradually smaller in pore size from outside to inside.

8. The slurry filtering device of claim 3, wherein the first filtering medium and the second filtering medium respectively include a PP (polypropylene) filter material, and a nominal pore size of the PP filter material is smaller than 0.5 μm.

9. The slurry filtering device of claim 3, wherein the first filtering medium and the second filtering medium are pre-wetted.

10. The slurry filtering device of claim 4, wherein the inlet portion and the outlet portion respectively include an expanded tube connector, each said expanded tube connector is for being liquid-tightly connected to a tube member, the first filter and the second filter are coaxially arranged, the first filter and the second filter are respectively cylindrical, the first filter and the second filter are axially opposite to each other and have a separating space therebetween, the first filtering medium has a first folded layer on an inner side thereof, the first folded layer is radially folded to and fro around the first axial direction and continuously layered circumferentially, the second filtering medium has a second folded layer on an outer side thereof, the second folded layer is radially folded to and fro around the second axial direction and continuously layered circumferentially, the first filter further has a first side cover, the second filter further includes a second side cover, the first side cover covers a side of the first filtering medium, the second side cover covers a side of the second filtering medium, and a smallest pore of the second filtering medium is smaller than a smallest pore of the first filtering medium.
